(19) United States
(12) Patent Application Publication
(10) Pub. No.: US 2023/0007011 A1
(43) Pub. Date: Jan. 5, 2023

(54) METHOD AND SYSTEM FOR MANAGING IMPERSONATED, FORGED/TAMPERED EMAIL

(71) Applicant: REALSECU Co., Ltd., Busan (KR)

(72) Inventor: Hee Soo JUNG, Busan (KR)

(73) Assignee: REALSECU Co., Ltd., Busan (KR)

(21) Appl. No.: 17/783,644

(22) PCT Filed: Dec. 23, 2020
(86) PCT No.: PCT/KR2020/019040

§ 371 Date: Jun. 9, 2022

(30) Foreign Application Priority Data
Apr. 22, 2020 (KR) 10-2020-0048632

(51) Int. Cl. H04L 9/40

(52) U.S. Cl. CPC H04L 63/126; H04L 63/1483

(57) ABSTRACT

The present invention relates to a method and system for managing an impersonated or forged/tampered email. To this end, the present invention provides a method and a system for managing an impersonated or forged/tampered email, the method comprising: a step in which, when an email is received at an email account of a recipient email server through a network, a system for managing an impersonated or forged/tampered email, positioned between the network and the recipient email server, generates verification request information including details of the received email and a sender email address and transmits same to the sender email address of the received email; a step in which, when the verification request information is provided, a sender email server of the sender email address checks if the sender email address included in the verification request information is valid, and returns an error code to the system for managing the impersonated or forged/tampered email when the sender mail address is not valid; and a step in which, when the error code is returned, system for managing the impersonated or forged/tampered email blocks the received email.

### TECHNICAL FIELD

The present invention relates to a received mail detection technology, and more particularly, to a phishing or forged or altered mail management method and system that use the psychology of a person who prevents people from finding himself or herself by disguising himself or herself by analyzing psychological characteristics of impersonated senders and forged or altered senders, that is, protect well-intended mail users against malicious senders by detecting and blocking impersonated senders and forged or altered senders using an error code which is developed to prevent the loss of outgoing mail of a mail system.

### BACKGROUND ART

Spam mail, which is advertisement mail delivered unilaterally to a large number of unspecified communication users, is causing more problems due to the spread of the Internet and the development of technology.

Conventionally, email security systems have been developed and run to prevent spam mail, but there are clear technological limitations. The technical parts are language-based keyword filtering and malware detection. Most companies that develop information security systems are trying to develop technologies to solve the corresponding security problems in a short time. Conventionally, a technology for detecting keywords and malware on the basis of a blacklist and the like is used in a way of analyzing, comparing, and blocking a technical method of an attack.

Since the blacklist technology requires a relatively short development period and brings about immediate effects, most mail security technologies are developed on the basis of a blacklist. However, the blacklist technology has a major drawback in that it is possible to neither detect nor block new methods and patterns.

Also, according to the technology for detecting and blocking keywords and malware, it is difficult to block new types of attacks because the attacks are not detected.

The number-one problem in recent email security is damage from mail impersonating government agencies or mail forged or altered as acquaintances. Mailing by impersonating, forging, or altering a mail sender makes a recipient receive or view the corresponding mail without doubt and thereby causes severe damage such as leakage of personal information or even financial damage.

However, it is difficult for existing email security systems to detect and block phishing mail and forged or altered mail. This is because the content and attached files of recent phishing mail and forged or altered mail do not contain illegal content which is detectable by mail security systems in most cases. In this regard, the Korea Internet & Security Agency and information protection agencies merely recommend recipients to immediately delete phishing mail and forged or altered mail without viewing the content.

A more detailed description is as follows. All pieces of spam mail are sent by impersonated, forged, or altered senders. In the past, however, mail content and attached files were malicious and thus detected and blocked by mail security systems, which is not very problematic. For this reason, spammers continuously studied a new attack method and turned an email attack method to phishing mail, spear phishing, etc. When the phishing mail and the like is analyzed, there is no problematic content. However, when a recipient receives and clicks the mail, the recipient comes to achieve the purpose intended by the sender. To solve this problem, various mail security technologies for accurately checking email senders are being developed and applied internationally. Such mail security technologies include sender policy framework (SPF), domain keys identified mail (DKIM), domain-based message authentication (DMARC), etc. However, the currently developed technologies have a limitation that they work only when the same technology is applied to the sender and the recipient.

In other words, to apply the corresponding mail security technology, the corresponding mail security technology should be simultaneously applied to numerous mail systems all over the world, so messages can be smoothly delivered through mail. When the corresponding mail security technology is applied to only one side, mail cannot be received. Therefore, it is difficult to apply the corresponding technologies, and mail users are recommended not to receive unknown mail.

For this reason, there is an increasing demand for the development of mail security technology for protecting well-intended mail users against phishing mail and forged or altered mail.

### DISCLOSURE

### Technical Problem

The present invention is directed to providing phishing or forged or altered mail management method and system that use the psychology of a person who prevents people from finding himself or herself by disguising himself or herself by analyzing psychological characteristics of impersonated senders and forged or altered senders, that is, protect well-intended mail users against malicious senders by detecting and blocking impersonated senders and forged or altered senders using an error code which is developed to prevent outgoing mail of a mail system from being lost without being delivered.

### Technical Solution

One aspect of the present invention provides a method of managing phishing or forged or altered mail, the method including, when mail is received in a mail account of a recipient mail server through a network, generating and transmitting, by a phishing or forged or altered mail management system interposed between the network and the recipient mail server, verification request information including content of the received mail and a sender mail address to the sender mail address of the received mail, when the verification request information is provided, checking, by a sender mail server of the sender mail address, whether the sender mail address included in the verification request information is valid and, when the sender mail address is invalid, returning an error code to the phishing or forged or altered mail management system, and when the error code is returned, blocking, by the phishing or forged or altered mail management system, the received mail.

### Advantageous Effects

The present invention uses the psychology of a person who prevents people from finding himself or herself by disguising himself or herself by analyzing psychological characteristics of impersonated senders and forged or altered senders, that is, makes it possible to detect and block impersonated senders and forged or altered senders using an error code which is developed to prevent outgoing mail of a mail system from being lost.

In this way, according to the present invention, impersonated senders and forged or altered senders are determined, and outgoing mail of the senders is fundamentally blocked. Consequently, damage can be remarkably reduced.

### DESCRIPTION OF DRAWINGS

FIG. 1 is a block diagram of a mailing system equipped with a phishing mail management system according to an exemplary embodiment of the present invention.

FIG. 2 is a block diagram of the phishing mail management system according to the exemplary embodiment of the present invention.

FIG. 3 is a sequence diagram of a phishing mail management method according to an exemplary embodiment of the present invention.

FIG. 4 is a block diagram of a mailing system equipped with a forged or altered mail management system according to an exemplary embodiment of the present invention.

FIG. 5 is a block diagram of the forged or altered mail management system according to the exemplary embodiment of the present invention.

FIG. 6 is a sequence diagram of a forged or altered mail management method according to an exemplary embodiment of the present invention.

### MODES OF THE INVENTION

Before detailed description of the present invention, a method of detecting phishing mail and forged or altered mail will be described.

Mail systems may be roughly classified into a receiving mail system and a sending mail system. The receiving mail system is a mail system that can also send mail, and this is a generally-used common mail system. The sending mail system is a mail system that can only send mail and cannot receive mail. This mail system checks only a receiving side and transmits mail without checking a sender or a sending mail system. The sending mail system is used for sending a large amount of advertising mail or spam mail, forged or altered mail, phishing mail, etc.

Therefore, the present invention checks an error code indicating a situation in which it is impossible to receive outgoing mail to determine whether the mail is forged or altered and whether the mail is phishing mail.

In general mail systems, when it is impossible to receive outgoing mail, the following error code is returned to the sender.

>421 Server too busy; Receiving-side server response delay; A situation in which mail cannot be received due to traffic of the receiving server and the like.

>421 Microsoft ESMTP MAIL Service, Version: 5.0.2195.5600 ready at Service not available, closing transmission channel; A situation in which mail cannot be received due to a simple mail transfer protocol (SMTP) server failure of Microsoft (MS).

>441 4.4.1 No answer from host; A message returned because there is no response from a receiving server.

>441 4.4.0 DNS resolving error; A message returned because the domain of a receiving server is not found.

>451 4.3.0 Other or undefined mail system status; A case in which a receiving-side mail system has a different protocol or is not a receiving SMTP server.

>451 4.3.0 Temporary system failure. Please try again later; A case in which mail is not received due to temporary failure of a receiving server.

>451 4.4.2 Bad connection (io timeout); A message returned as response time expires because there is no response from a receiving server.

>451 Relay Server Not Ready.; A message returned because a relay function does not work in a receiving server.

>452 4.4.5 Insufficient disk space; try again later; A message returned because mail is not received due to the insufficient disk capacity of a receiving server.

>452 4.4.5 . . . Insufficient disk space; try again later; A case in which mail is not received due to the insufficient mailbox capacity of a recipient.

>500 Syntax Error, Command Unrecognized EHLO mo02.hanafos.com; A message returned when mail is sent because a receiving-side mail server cannot recognize an SMTP command.

>500 5.5.1 Command unrecognized: “XXXX mo02.hanafos.com”; A case in which a receiving server cannot recognize an SMTP command (same as above).

>501 Denied domain name; A case in which an incorrect domain address is input or a receiving side rejects a domain.

>501 5.1.8 Sender domain must exist(honorstech.com); A message returned because the domain of a receiving side does not exist.

>502 Not implemented; A message returned because a receiving server cannot recognize an SMTP command.

>505 Authentication required; A message returned because a receiving server does not allow relay authentication and the like.

>512 5.1.2 Bad destination system address; A message returned because a receiving server cannot respond due to a failure of the receiving server, network traffic, etc.

>550 Requested action not taken: mailbox unavailable; A message returned because the mailbox of a recipient is not found.

>550 Mail is rejected (filtering rejection); A message returned because the mail address or Internet protocol (IP) address of a sender is filtered out and rejected by a receiving server.

>550 Invalid recipient singha@rrr.com; A message returned because a recipient account is not found.

>550 RCPT ERROR. Mailbox doesn't exist; A message returned because the mailbox of a recipient does not exist.

>550 5.1.1 . . . User unknown; A message returned because a recipient (ggg@fff.co.kr) account is not found.

>550 5.1.1 Suspended user; A case in which the user account of a receiving side is suspended.

>550 5.1.2 . . . Unsupported mail destination; A message returned because the response of a receiving server is delayed.

>550 5.7.1 . . . Relaying denied. IP name lookup failed [10.10.10.10]; A case in which mail is not transmitted because a receiving server rejects relaying from the IP address of a sender.

>550 5.7.1 Unable to relay for ttt@hhh.net; A message returned when a receiving server rejects relaying.

>553 sorry, your envelope sender is in my badmailfrom list; A message returned because the mail address of a sender has been registered in the blacklist of a recipient server.

>553 sorry, that domain isn't in my list of allowed rcpt hosts; A message returned because the mail domain address of a sender has been blocked by a receiving server.

>553 sorry, your envelope sender is listed as spammer; A message returned because the mail address of a sender has been registered in the spammer list of a receiving server.

>553 This target address is not our MX service; A message returned when the address of a recipient is a domain not serviced by a receiving server or the domain of a sender is confirmed not to exist.

>553 5.0.0 We do not accept mail from spammers—If you have questions, please mail admins@www.yyy.net.; A message returned because the mail address of a sender has been registered as a spammer in a receiving server.

>553 5.0.0 Your message may contain the Win32.Klez worm!!—If you have questions, please mail postmasters@mail.bbb.co.kr.; A case in which a message is not received but returned because worm virus “Win32.Klez” has been found in the mail of a sender.

>554 Recipient address rejected: Access denied; A state in which a recipient has blocked the account of a sender.

>554 delivery error: dd Sorry, your message to singha@yahoo.co.kr cannot be delivered. This account is over quota.—mta111.mail.yahoo.co.kr; A message returned because the mailbox capacity of a recipient is insufficient.

>554 5.1.0 Sender Denied; A case in which the account of a sender is blocked by a receiving server.

>554 5.3.0 Mail has traversed too many hops. Reject it.; A message returned when a sender sends mail because the mail accounts of recipients input for group mail exceed a number limited by a receiving server.

>554 5.3.2 Rejected by mailbox host. REPLY:(250 . . . Sender ok); A message returned because a recipient blocks the mail account of a sender.

>554 5.3.2 Rejected by mailbox host. REPLY:(550 5.1.1 unknown or illegal alias: aaa@xxx.com); A message returned because a recipient blocks the mail account of a sender.

When outgoing mail is not transmitted to a recipient for the reason described above, a mail system automatically generates an error value regarding the reason that the outgoing mail has not been received and notifies a sender of the error value.

Also, when the mail transmitted by the sender is delivered to the recipient normally, no error value is returned to the sender.

However, when the mail is not delivered to the recipient, the mail system provides a notification that the mail of the sender has not been delivered to the recipient normally due to several technical problems on the receiving side, other reasons that the mail has not been received, etc. to technically prevent the mail from being lost.

As described above, an error code for outgoing mail is for preventing, when the outgoing mail is not received, the loss of the outgoing mail by notifying a sender of the corresponding content and reason. A phishing or forged or altered mail management system according to the present invention detects and blocks mail of which a sender is impersonated or forged or altered using the above error codes.

More specifically, a sender who is impersonated or forged or altered cannot receive mail that is sent by the phishing or forged or altered mail management system and includes verification request information. This is because the sender impersonates, forges, or alters an originating mail address. Such impersonation, forgery, or alteration may be classified into some cases.

In a first case, all pieces of information including the mail account, mail server, etc. of a sender to be impersonated are falsely used. In a second case, only the sender is impersonated, and a send-only mail server, which is a private mail server, is used for a mail account and mail server. In a third case, a mail account and mail server are created to be similar to the mail account and mail server of an existing sender and used, that is, the mail account and mail server of a sender are forged or altered so that a recipient cannot accurately distinguish the sender.

Therefore, according to the present invention, every time mail for a recipient-side mail server is received, mail including verification request information is transmitted to a sender side, and when an error code or verification information is returned from the sender side, it is determined whether the mail is phishing or forged or altered mail according to the error code or verification information such that the mail is blocked.

In other words, in the first phishing case, mail including verification request information is not sent to an impersonating sender but to a user who is impersonated. Accordingly, the impersonated user is able to recognize that his or her mail account has been falsely used, and verification information indicating that the mail account has been falsely used is returned in response to the verification request information such that the corresponding mail is blocked according to the verification information.

In the second phishing case, an originating mail account is falsely used, and thus mail including verification request information cannot find the originating mail account. Accordingly, an error code is returned to the phishing mail management system. When the error code is received, the phishing or forged or altered mail management system blocks the corresponding mail.

In the third forged or altered case, a sender uses a private mail server (a send-only mail server) and thus cannot receive a verification value. Accordingly, an error code is returned to the phishing or forged or altered mail management system. When the error code is received, the phishing or forged or altered mail management system blocks the corresponding mail.

As described above, according to the present invention, every time mail for a recipient-side mail server is received, mail including verification request information is transmitted to a sender side, and when an error code or verification information is returned from the sender, it is determined whether the mail is phishing or forged or altered mail according to the error code or verification information such that the mail is blocked.

In this way, according to the present invention, impersonated senders and forged or altered senders are determined, and their outgoing mail is fundamentally blocked. Consequently, damage can be remarkably reduced.

Such a phishing or forged or altered mail management system according to an exemplary embodiment of the present invention will be described in detail with reference to the drawings.

<Configuration of Phishing Mail Management System>

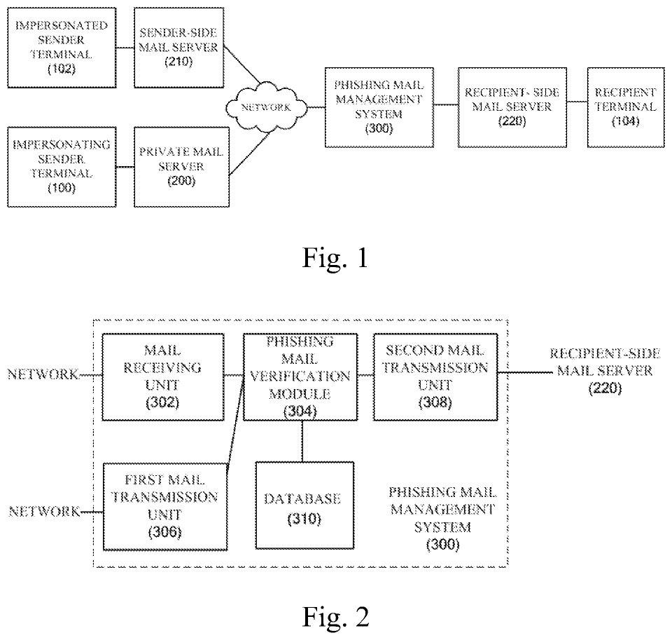

FIG. 1 is a block diagram of a phishing mail management system according to an exemplary embodiment of the present invention.

Referring to FIG. 1, a phishing mail management system 300 according to the exemplary embodiment of the present invention is connected between a recipient-side mail server 220 and a network to detect and block phishing mail among pieces of mail transmitted to the recipient-side mail server 220 through the network.

More specifically, every time mail is received by a mail account of the recipient-side mail server 220, the phishing mail management system 300 transmits mail including verification request information to a sender mail address of the received mail. When a sender-side mail server returns an error code corresponding to the mail including the verification request information, the received mail is determined as phishing mail and blocked.

On the other hand, when no error code is returned according to the verification request information, the received mail is provided to a recipient through a recipient terminal 104 that is accessing a mail account of the recipient-side mail server 220.

To detect phishing mail more thoroughly, the phishing mail management system 300 provides mail including verification request information to a sender. The phishing mail management system 300 provides the received mail to a recipient only when the sender checks the mail and returns verification information indicating that the mail is normal mail.

On the other hand, when the sender of the mail returns verification indicating that the verification-requested mail is phishing mail, the phishing mail management system 300 determines the mail as a phishing mail and blocks the mail.

Also, every time phishing mail is blocked, the phishing mail management system 300 generates a report indicating that phishing mail has been received and provides the report information to the recipient through the recipient terminal 104 that is accessing the mail account of the recipient-side mail server 220.

FIG. 2 is a block diagram of the phishing mail management system according to the exemplary embodiment of the present invention.

Referring to FIG. 2, the phishing mail management system 300 includes a mail receiving unit 302 that receives mail, verification information, and an error code through the network and transmits the mail, the verification information, and the error code to a phishing mail verification module 304, a first mail transmission unit 306 that receives mail including the verification request information from the phishing mail verification module 304 and transmits the mail, a database 310 that stores error code information for error code determination, phishing mail history information, information for report creation, etc., a second mail transmission unit 308 that delivers the received mail to the recipient-side mail server 220 when the received mail is normal mail, and the phishing mail verification module 304 that receives the mail through the mail receiving unit 302, generates the mail including the verification request information for the received mail, transmits the generated mail to a sender mail address through the first mail transmission unit 306, determines whether the corresponding mail is phishing mail on the basis of a reply to the verification request information, generates and delivers a report about details of receiving the phishing mail to a user of a corresponding mail account through the recipient-side mail server 220 when the mail is phishing mail, and provides the mail to the user of the corresponding mail account through the recipient-side mail server 220 when the mail is not phishing mail.

<Procedure of Phishing Mail Management Method>

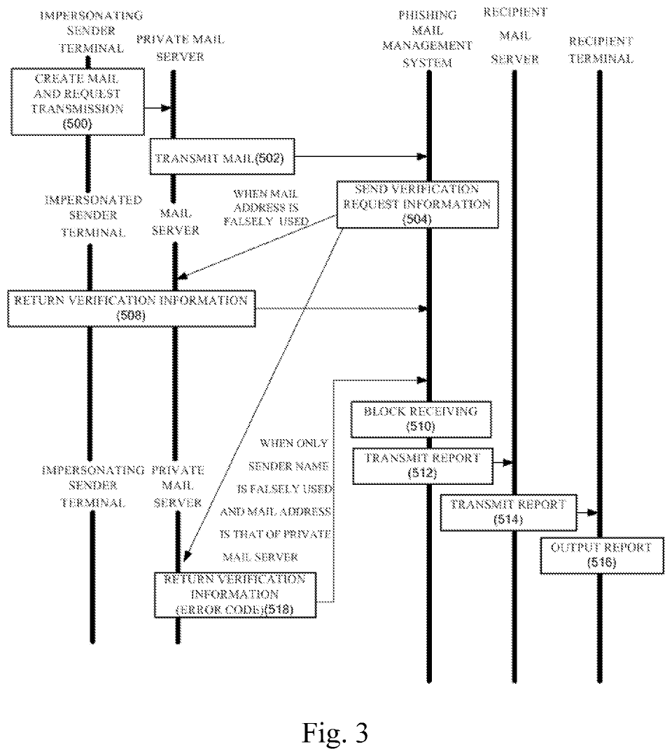

FIG. 3 is a sequence diagram of a phishing mail management method according to an exemplary embodiment of the present invention.

An impersonating sender creates phishing mail using an impersonating sender terminal 100 which is his or her own terminal and transmits the phishing mail to a private mail server 200 (operation 500). Then, the private mail server 200 transmits the phishing mail to a phishing mail management system 300 installed in front of a recipient-side mail server 220 (operation 502). In the phishing mail, both a sender name and a mail address may be falsely used, or only a sender name may be falsely used.

Every time mail is received, to determine whether the mail is phishing mail, the phishing mail management system 300 generates and transmits mail including verification request information to a mail server corresponding to a sender address of the received mail (operation 504). The verification request information may include the received mail, partial content of the received mail, the sender mail address, etc.

Here, when the impersonating sender falsely uses the mail address as well as the sender name, the mail including the verification request information is delivered to a mail server 210 that provides a mail account of a sender subjected to impersonation.

When the sender mail address is normal, the mail server 210 that provides the account of the sender subjected to impersonation provides the verification request information to the sender subjected to impersonation through an impersonated sender terminal 102. The sender subjected to impersonation determines whether he or she is impersonated by checking the mail content included in the verification request information through his or her own terminal 102 and transmits verification information indicating that the mail is phishing mail to the phishing mail management system 300 through the mail server 210 when he or she is impersonated (operation 508)

When the verification information indicating that the mail is phishing mail is received from the impersonated sender terminal 102, the phishing mail management system 300 blocks receiving of the received mail (operation 510) and creates and provides a report indicating that phishing mail has been received to the recipient terminal 104 through the mail server 220 (operation 514). The recipient terminal 104 outputs the report to notify the recipient that the phishing mail has been received (operation 516).

On the other hand, when the impersonating sender falsely uses only the sender name, the verification request information is delivered to the private mail server 200.

When the verification request information is received, the private mail server 200 transmits an error code (operation 518) because the private mail server 200 is a send-only mail server. The error code indicates that it is impossible to find a mail account of the corresponding mail address or a mail server of the sender.

When the error code is received from the private mail server, the phishing mail management system 300 blocks the received mail (operation 510) and creates and provides a report indicating that the phishing mail has been received to the recipient terminal 104 through the recipient-side mail server 220 (operation 514). The recipient terminal 104 outputs the report to notify the recipient that the phishing mail has been received (operation 516).

Also, it may be set in advance that, when the address of the received mail is normal, the mail server receiving the verification request information does not provide an error code for a predetermined time period and the user does not receive verification information of the mail. In this case, the phishing mail management system may deliver the received mail to the recipient through the recipient-side mail server 220, which is apparent to those of ordinary skill in the art.

Further, the user may set the phishing mail management system 300 in advance so that mail is verified only when a sender of the mail is not the user of a preset mail address, which is apparent to those of ordinary skill in the art.

<Configuration of Forged or Altered Mail Management System>

A forged or altered mail management method and system according to an exemplary embodiment of the present invention will be described below.

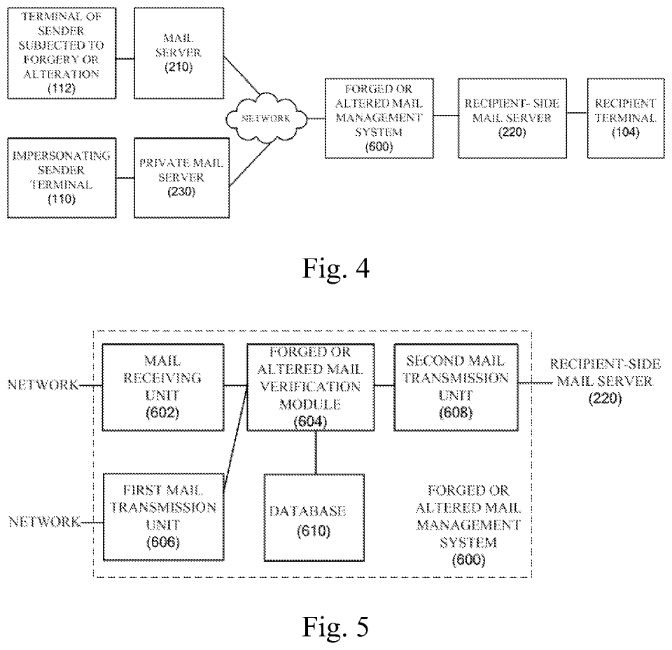

FIG. 4 is a block diagram of a forged or altered mail management system according to an exemplary embodiment of the present invention.

Referring to FIG. 4, a forged or altered mail management system 600 is connected between a recipient-side mail server 220 and a network to detect and block phishing mail among pieces of mail transmitted to the recipient-side mail server 220 through the network.

More specifically, every time reply mail or reply mail for a reply is received for a mail account of the recipient-side mail server 220, the forged or altered mail management system 600 transmits mail including verification request information to a sender mail address of the received mail. When a sender-side mail server returns an error code corresponding to the mail including the verification request information, the received mail is determined as phishing mail and blocked.

Also, every time forged or altered mail is blocked, the forged or altered mail management system 600 generates report information indicating that forged or altered mail has been received and provides the report information to a recipient through a recipient terminal 104 that is accessing the mail account of the recipient-side mail server 220.

FIG. 5 is a block diagram of the forged or altered mail management system 600 according to the exemplary embodiment of the present invention.

Referring to FIG. 5, the forged or altered mail management system 600 includes a mail receiving unit 602 that receives mail, verification information, and an error code through the network and transmits the mail, the verification information, and the error code to a forged or altered mail verification module 604, a first mail transmission unit 606 that receives mail including the verification request information from the forged or altered mail verification module 604 and transmits the mail, a database 610 that stores error code information for error code determination, forged or altered mail history information, information for report creation, etc., a second mail transmission unit 608 that delivers the received mail to the recipient-side mail server 220 when the received mail is normal mail, and the forged or altered mail verification module 604 that receives the mail through the mail receiving unit 602, generates the mail including the verification request information for the received mail, transmits the generated mail to a sender mail address through the first mail transmission unit 606, determines whether the corresponding mail is forged or altered mail on the basis of a reply to the verification request information, generates and delivers a report about details of receiving the forged or altered mail to a user of a corresponding mail account through the recipient-side mail server 220 when the mail is forged or altered mail, and provides the mail to the user of the corresponding mail account through the recipient-side mail server 220 when the mail is not forged or altered mail.

<Procedure of Forged or Altered Mail Management Method>

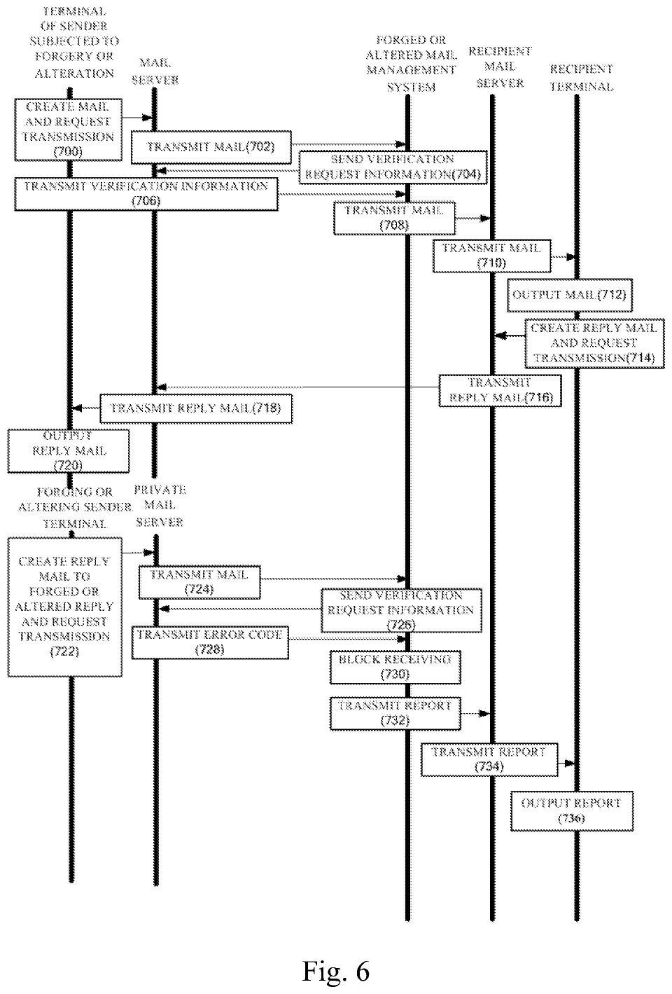

FIG. 6 is a sequence diagram of a forged or altered mail management method according to an exemplary embodiment of the present invention.

Referring to FIG. 6, a sender subjected to forgery or alteration creates mail using a sender terminal 112 of the sender subjected to forgery or alteration which is his or her own terminal and transmits the mail to a mail server 210 for transmission to a recipient side (operation 700). The mail server 210 transmits the created mail to a forged or altered mail management system 600 installed in front of a recipient-side mail server 220 (operation 702).

The forged or altered mail management system 600 generates and transmits mail including verification request information to the sender-side mail server 210 that has transmitted the mail (operation 704). The verification request information is transmitted to a mail account of the sender to determine whether the mail is forged or altered mail. The mail server 210 transmits verification request information to the sender through the mail account of the sender, and when the sender provides verification information according to the verification request information, the mail server 210 transmits the verification information to the forged or altered mail management system 600 (operation 706). When the verification information is sent with normal mail, the forged or altered mail management system 600 delivers the corresponding mail to the recipient-side mail server 220 (operation 708). The recipient-side mail server 220 provides the mail to the recipient through a mail account of the recipient (operation 710). The recipient receives and outputs the mail arriving in the mail account of the mail server 220 through a recipient terminal 104 which is his or her own terminal and may create reply mail to the output mail and request the mail server 220 to transmit the reply mail (operations 712 and 714).

The recipient-side mail server 220 that receives the reply mail provides the reply mail to the sender terminal 112 through the mail server 210 (operations 716 and 718).

The sender terminal 112 receives and outputs the reply mail arriving in the account thereof such that reply content may be checked (operation 720).

During such a normal mailing process, a forging or altering sender may intercept the mail and generate forged or altered mail. The forging or altering sender intercepts the reply mail through his or her own terminal, that is, a terminal 110 of the forging or altering sender, to generate reply mail to the reply and transmits the reply mail to the reply to the recipient-side mail server 220 through a private mail server 230 (operations 722 and 724).

The reply mail to the reply transmitted by the private mail server 230 is delivered to the forged or altered mail management system 600 located in front of the recipient-side mail server 220.

The forged or altered mail management system 600 determines whether a sender address of the corresponding mail is a new mail address. When the mail address is new, the forged or altered mail management system 600 generates mail including verification request information and transmits the verification request information to the private mail server 230 according to the sender mail address of the received mail (operation 726). Since the private mail server 230 is a send-only mail server, an error code is returned when the verification request information is received (operation 728). The error code indicates that it is not possible to find a mail account of the sender or a mail server of the sender.

When the error code is received, the forged or altered mail management system 600 blocks the corresponding mail and creates and provides a report indicating that the forged or altered mail has been received to the recipient terminal 104 through the recipient-side mail server 220 (operations 730 and 732). The recipient terminal 104 outputs the report and notifies the recipient that the forged or altered mail has been received (operation 736).

As described above, according to the present invention, every time mail for a recipient-side mail server is received, mail including verification information is transmitted to a sender side. When an error code or verification information is returned from the sender side, it is determined whether the mail is phishing mail or forged or altered mail according to the verification information, and the mail is blocked.

In this way, according to the present invention, impersonated senders and forged or altered senders are determined, and outgoing mail of the senders is fundamentally blocked. Consequently, damage can be remarkably reduced.

The technical ideas described above in the embodiments of the present invention can be implemented separately or in combination. Although the present invention has been described with reference to the embodiments illustrated in the drawings and detailed description of the invention, these are merely exemplary, and various modifications and equivalent other embodiments can be made by those of ordinary skill in the art. Therefore, the technical range of the present invention should be determined by the appended claims.

### DESCRIPTION OF SIGNS

100: impersonating sender terminal

102: impersonated sender terminal

104: recipient terminal

200: private mail server

210, 220: mail server

300: phishing mail management system

302: mail receiving unit

304: phishing mail verification module

306: first mail transmission unit

308: second mail transmission unit

310: database

### INDUSTRIAL APPLICABILITY

The present invention relates to a mail security technology and can be applied to a mail security system that not only blocks spam mail but also protects well-intended mail users against phishing mail and forged or altered mail.

Also, the present invention can be applied to an information security system that detects and blocks keywords and malware.

1. A method of managing phishing or forged or altered mail, the method comprising:
(a) every time mail is received in a mail account of a recipient mail server, generating and transmitting, by a phishing or forged or altered mail management system interposed between a network and the recipient mail server, verification request information including content of the received mail and a sender mail address to the sender mail address of the received mail;
(b) when the verification request information is provided and is received normally by a sender mail server of the sender mail address, determining that the sender mail address has not been falsely used or forged or altered and returning no error code and, when the sender mail server is not allowed to receive the verification request information, returning an error code to the phishing or forged or altered mail management system in response to the verification request information; and
(c) receiving, by the phishing or forged or altered mail management system, only sender mail for which the error code is not returned for a certain time after the verification request information is transmitted.

2. The method of claim 1, wherein operation (c) further comprises, when verification information indicating that the received mail is normal outgoing mail is returned or the error code is not returned, transmitting, by the phishing or forged or altered mail management system, the received mail to the recipient mail server so that the received mail is delivered to a recipient mail address included in the received mail.

3. The method of claim 1, wherein the error code is an error code indicating that a mail account of the corresponding mail address or the mail server of a sender is not findable.

4. The method of claim 1, further comprising, every time the phishing or forged or altered mail management system blocks the received mail, generating and transmitting report information including receiving and blocking information of the phishing mail to the recipient mail server so that the report information is delivered to a recipient mail address included in the received mail.

5. A phishing or forged or altered mail management system positioned between a recipient mail server and a network through which a plurality of sender and recipient terminals, a sender mail server, and the recipient mail server are connected, the phishing or forged or altered mail management system comprising:
a mail receiving unit configured to receive mail through the network;
a first mail transmission unit configured to transmit verification request information including content of the mail and a sender mail address received by the mail receiving unit to a sender mail server corresponding to the sender mail address through the network;
a second mail transmission unit configured to transmit the mail to the recipient mail server; and
a forged or altered mail verification module configured to generate and transmit the verification request information to the sender mail server through the first mail transmission unit when the mail is received from the mail receiving unit and block the received mail when receiving an error code, which indicates that the sender mail server is not allowed to receive the verification request information, from the sender mail server through the mail receiving unit in response to the verification request information or when verification information generated through the sender terminal indicating that the received mail is abnormal outgoing mail is returned in response to the verification request information.

6. The phishing or forged or altered mail management system of claim 5, wherein, when verification information indicating that the received mail is normal outgoing mail is returned from the sender mail server or the error code is not received from the sender mail server, the forged or altered mail verification module transmits the received mail to the recipient mail server so that the received mail is delivered to a recipient mail address included in the received mail, and
every time the received mail is blocked, the forged or altered mail verification module generates and transmits report information including receiving and blocking information of the phishing mail to the recipient mail server so that the report information is delivered to the recipient mail address included in the received mail.
